(19) United States
(12) Patent Application Publication
(10) Pub. No.: US 2018/0315453 A1
(43) Pub. Date: Nov. 1, 2018

(54) AUDIO INTEGRATED CIRCUIT

(71) Applicant: TYMPHANY WORLDWIDE ENTERPRISES LIMITED, Taipei (TW)

(72) Inventors: Dimitris GRIMANIS, Taipei (TW); Ruben Minoru MILLYARD, Taipei (TW)

(21) Appl. No.: 15/966,502

(22) Filed: Apr. 30, 2018

Related U.S. Application Data
(60) Provisional application No. 62/491,814, filed on Apr. 28, 2017.

(51) Int. Cl. G11B 27/031; G11B 20/10

(52) U.S. Cl. CPC G11B 27/031; G11B 20/10

(57) ABSTRACT

An audio integrated circuit includes an electronic mixer circuit configured to output a mixed audio signal, a comparator circuit in signal communication with the mixer, the comparator circuit configured to output a binary signal based on a comparison between the mixed audio signal and a threshold value, a negator circuit in signal communication with the comparator circuit, the negator circuit configured to convert the binary signal into a data format corresponding to a serial data output port to generate a converted binary signal and a configurable serial data output port in signal communication with the negator circuit, the serial data output port configured to generate an output signal based on the converted binary signal.

### CROSS REFERENCE TO RELATED APPLICATIONS

This nonprovisional application claims priority to U.S. Provisional Application No. 62/491,814, which was filed on Apr. 28, 2017 and which is herein incorporated by reference.

### BACKGROUND OF THE INVENTION

### Field of the Invention

The present invention relates to an audio integrated circuit and more particularly to an audio integrated circuit including a SDATA port configurable to provide an additional SDATA output that operates as a GPIO.

### Description of the Background Art

An audio integrated circuit (IC) commonly includes one or more available General Purpose Inputs/Outputs (GPIOs). Those GPIOs serve the purpose of transmitting/receiving binary information to/from other electrical components. GPIOs are typically assigned user-designated settings or dedicated outputs, which are then coded or stored in a data register, which defines how each GPIO is being used. Once the user-designated setting is coded in the register, the GPIO is typically limited thereto. However, it is not uncommon that in today's complex audio electrical circuits an audio IC may not have enough GPIOs available to host all the electrical functionality and signaling required by the electrical design.

### SUMMARY OF THE INVENTION

In view of the foregoing and other exemplary problems, drawbacks, and disadvantages of the conventional methods and structures, an exemplary feature of the present invention is to provide an audio IC including a serial data (SDATA) port that can be configured to provide a free or additional SDATA output pin that operates as a GPIO.

According to a first non-limiting, exemplary aspect of the invention an audio integrated circuit includes an electronic mixer circuit configured to output a mixed audio signal, a comparator circuit in signal communication with the mixer, the comparator circuit configured to output a binary signal based on a comparison between the mixed audio signal and a threshold value, a negator circuit in signal communication with the comparator circuit, the negator circuit configured to convert the binary signal into a data format corresponding to a serial data output port to generate a converted binary signal and a configurable serial data output port in signal communication with the negator circuit, the serial data output port configured to generate an output signal based on the converted binary signal.

According to a second non-limiting, exemplary aspect of the invention, an audio integrated circuit includes an electronic mixer circuit configured to output a mixed audio signal, a comparator circuit in signal communication with the mixer, the comparator circuit configured to output a binary signal based on a comparison between the mixed audio signal and a threshold value and a data output in signal communication with the comparator and configured to receive the binary signal from the comparator.

According to a third non-limiting, exemplary aspect of the invention, a method of outputting an audio signal includes mixing a first input audio component with a second input audio component to generate a mixed audio signal, outputting a binary signal based on a comparison between the mixed audio signal and a threshold value, converting the binary signal into a data format corresponding to a serial data output port to generate a converted binary signal and outputting the converted binary signal via the serial data output port.

Audio ICs often have one or more dedicated audio serial data ports. In cases where GPIOs on an IC are all occupied and such a port is available, then the SDATA port could be configured to make the SDATA output pin of the port act as an extra GPIO. In accordance with the exemplary aspects described above, the present invention is able to provide an audio IC including a SDATA port that can be configured to provide a free or additional SDATA output pin that operates as a GPIO.

Indeed, according to one or more non-limiting embodiments of the disclosure, an audio IC is provided that includes a SDATA port that can be configured to provide a free or additional SDATA output pin that operates as a GPIO. The SDATA output pin of an audio IC can output audio data in a corresponding format such as Inter-IC Sound (I²S), left-justified, right-justified, etc., which are referred to as “two's complement-based formats.” When the SDATA port is configured as an SDATA output pin, the SDATA port can output a series of zeros or ones on demand, indicating an electrical “low” or “high” whenever desired. To facilitate binary output data from the SDATA output pin, the configuration of the SDATA port includes converting the audio data into a format supported by the SDATA port, e.g., a two's complement-based format. In at least one embodiment, the SDATA port can be configured in response to feeding the SDATA output pin with the appropriate data format (e.g., the two's complement numbers) that translate respectively as a series of zeros and ones corresponding to the SDATA port. In the two's complement format, for example, the two's compliment numbers are 0 (for a series of zeros) and an inverse 1 (i.e., −1) (for a series of ones).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, do not limit the present invention, and wherein:

FIG. 1A illustrates a block diagram of an audio IC 100 including a GPIO according to an exemplary embodiment of the present invention;

FIG. 1B illustrates a block diagram of an audio IC 100 including a serial data output port according to an exemplary embodiment of the present invention;

FIG. 2 illustrates a block diagram of an audio IC 200 according to another exemplary embodiment of the present invention;

FIG. 3 is a signal diagram illustrating behavior of various signals of an audio IC including a configurable SDATA audio output port; and

FIG. 4 illustrates a method 400 of outputting an audio signal according to an exemplary embodiment of the present invention.

### DETAILED DESCRIPTION

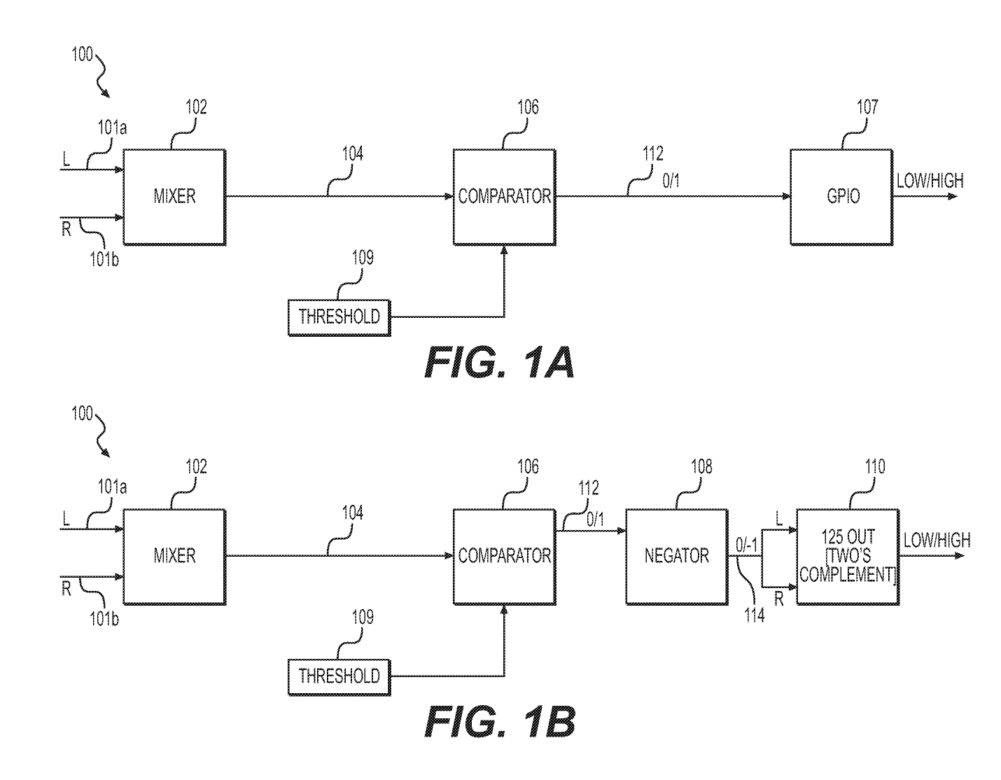

Referring now to the drawings, and more particularly to FIGS. 1A-4, there are shown exemplary embodiments of the present invention.

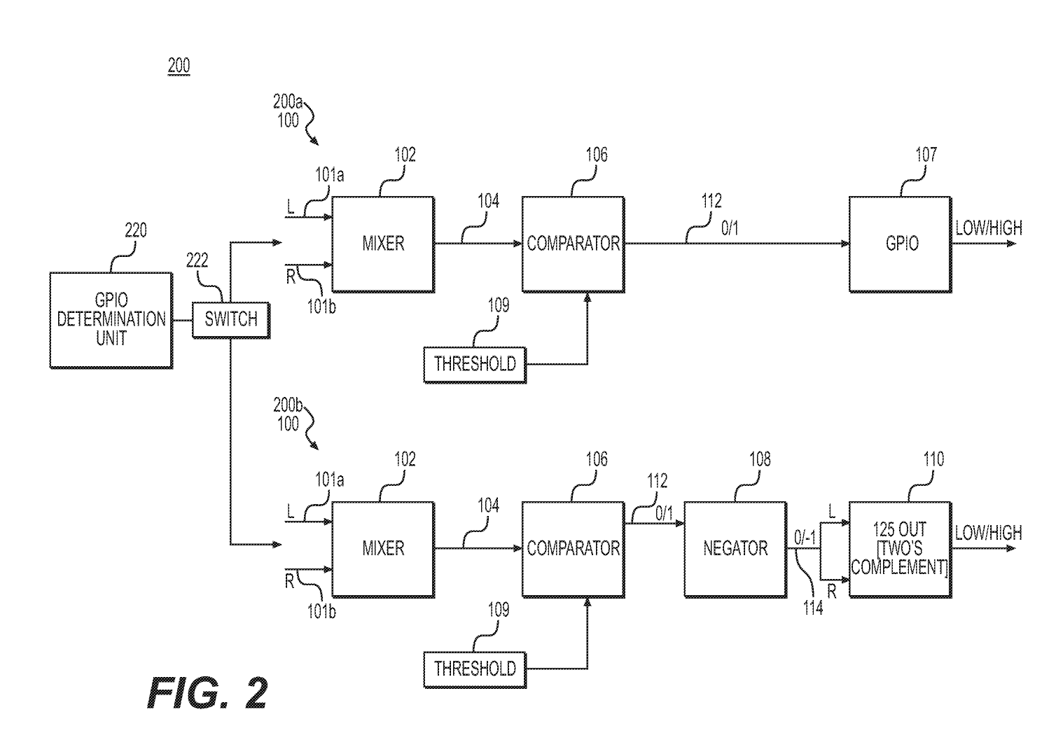

Various non-limiting embodiments described herein provide a circuit that is able to convert audio signal into the appropriate SDATA format (e.g., two's compliment format) and then utilize an SDATA port, i.e., SDATA output pin of an audio IC, in place of a GPIO, when a GPIO is not available. Turning to FIGS. 1A, 1B and 2, for example, an audio signal is determined to be higher or lower than a specific threshold. With reference to FIG. 1A, an audio IC 100 is illustrated, which includes a mixer 102, an audio channel 104, a comparator (i.e., comparator circuit) 106 and a GPIO 107. The mixer 102 is configured to receive an audio signal(s) and to output a mixed audio signal. The comparator 106 is in signal communication with the mixer 102 and is configured to compare the mixed audio signal to a stored threshold value 109 and then output a binary signal based on the comparison. When an audio signal or audio channel 104, such as a digital audio signal, for example, output from the mixer 102 is equal to or higher than the threshold 109, then a signal of “high” should be generated at an output pin. When the signal 104 is lower than the threshold 109 then a “low” should be generated at an output pin.

FIGS. 1A and 1B illustrates two scenarios at which an audio IC 100 determines a high signal or low signal. A first scenario shown in FIG. 1A illustrates an example of when a GPIO 107 is available. A second scenario shown in FIG. 1B illustrates an example of when no GPIOs are available.

In the latter case (i.e., when a GPIO 107 is unavailable), a configurable SDATA output port 110, e.g., an I²S output or SDATA output pin 110, is used instead. Referring to FIG. 1B, an audio IC 100 is illustrated according to a non-limiting embodiment. The audio IC 100 includes a mixer 102, an audio channel 104 and a comparator 106, as discussed above. Additionally, the IC 100 includes a negator (i.e., negator circuit) 108 and a configurable serial data (SDATA) port 110. The negator 108 is in signal communication with the comparator 106 and is configured to convert the binary signal output from the comparator 106 into a data format corresponding to a serial data output port to generate a converted binary signal. The configurable SDATA port 110 is in signal communication with the negator 108 and is configured to generate an output signal based on the converted binary signal from the negator 108.

In use, an audio signal (e.g., 101a/101b) such as a digital audio signal for example, is mixed in the mixer 102 to create a single audio channel 104. The audio channel or mixed signal 104 is fed to the comparator. The mixer 102 can be constructed as an electronic audio mixer circuit capable of mixing together a first audio component (e.g., a left audio component) and second audio component (e.g., a right audio component) as understood by one of ordinary skill in the art.

The comparator 106 can be constructed as an electronic operational amplifier (OP-AMP) comparator circuit, or digital processing circuit, for example. However, any comparator circuit known to one of ordinary skill in the art may be employed. The comparator 106 compares the level of the single audio channel 104 (i.e., the mixed audio signal output from the mixer 102) to a threshold 109. The threshold 109 can be user-defined, for example, and stored within a memory. The comparator 106 outputs a first value, e.g., “1” when the audio signal 101a/101b is higher or equal than the threshold 109 and a second value, e.g., “0” in the opposite case, i.e., when the audio signal 101a/101b is lower than the threshold 109. In at least one embodiment, the binary values of the comparator 106 are output continuously as the audio signal is continuously delivered to the inputs (e.g., L/R) of the mixer 102.

In the first approach illustrated in FIG. 1A, the comparator 106 generates a binary signal (e.g., containing a 0 bit value or a 1 bit value) 112 based on the comparison between the audio signal 101a/101b and the threshold 109. The binary signal 112 is then fed directly to an available GPIO 107. In the second approach illustrated in FIG. 1B, however, the binary signal 112 output from the comparator 106 is fed to the negator 108.

In a further embodiment illustrated in, for example, FIG. 2, the audio signal can be delivered to either a GPIO 107 or a SDATA port 110, via one or more switches based on the availably of GPIOs 107 in the audio IC 100. For example, the audio IC 200 illustrated in FIG. 2 includes a determination module 220. When the determination unit 220 determines a GPIO 107 is available, the audio signal is directed, by the switch 222, to the first circuit 200a (corresponding to the circuit illustrated in FIG. 1A) and is ultimately delivered to the available GPIO 107. When, however, no GPIOs 107 are available, the audio signal is directed, by the switch 222, to the second circuit 200b (corresponding to the circuit illustrated in FIG. 1B). The audio signal is converted into the appropriate format corresponding with the SDATA port 110, delivered to the SDATA port 110, and then output via the SDATA port 110. Accordingly, binary data such as digital audio data, for example, can still be output even though no GPIOs 107 are available on the audio IC 100.

Referring again to FIG. 1B, the negator 108 can be constructed as an electrical circuit including one or more logic gates, for example, and generates a converted binary signal 114. For example, the negator 108 can process or shape the data of the binary signal 108, e.g., a 0 and a 1, into a converted binary signal 114 containing a 0 and an inverse 1 (i.e., −1). In this manner, the negator 108 operates as a data formatting circuit that converts the audio signal in the appropriate data format (e.g., a two's compliment-based format), which can then be utilized by the SDATA port 110.

The converted binary signal 114 is fed in both the Left (L) input and Right (R) input of the configurable SDATA port 110. In at least one embodiment, the configurable SDATA port 110 is constructed as a synchronous, serial interface 110 such as, for example, an I²S output bus 110 or SDATA output pin 110. In this manner, the data at the SDATA output pin of a configured SDATA port 110 would be a continuous electrical signal that is “low” when the audio signal (e.g., music) is lower than the threshold 109 and “high” when the signal is higher or equal to the threshold 109. Therefore, at least one non-limiting embodiment provides an audio IC 100 including a configurable SDATA port 110 that can be configured to provide a SDATA output pin that operates as a dedicated GPIO to send out binary information on other ICs. In this manner, when no dedicated GPIOs 107 are available on the audio IC 100, binary data can still be output via the configured SDATA port 110. That is, unlike a conventional GPIO, which is typically limited to its dedicated user-designated output or user-setting, the SDATA port 110 can be configured according to the format generated by the negator circuit 108.

Furthermore, in accordance with another exemplary embodiment of the present invention, the audio IC 100 can be arranged without the mixer 102. Specifically, the level of the audio signal inside any DSP can be detected and fed (e.g., directly) to the comparator 106. The comparator 106 would compare the signal with a threshold and either output 0 (if the audio signal is lower than the threshold) or 1 (if the audio signal is higher than the threshold). This 0 or 1 would then be routed to a GPIO to raise this signal level flag to any other IC that might need this information (for example, turn the amplifier off if the audio signal in the DSP is below the defined threshold). Any audio signal can be fed in the comparator 102 and compared with a threshold. In general, for using the SDATA pins as GPIO for signifying audio level status, it is not mandatory to mix anything in advance. Feeding any audio signal in the comparator 102 and comparing it with a threshold would result in either a value of 0 (lower than the threshold) or a 1 (higher than the threshold).

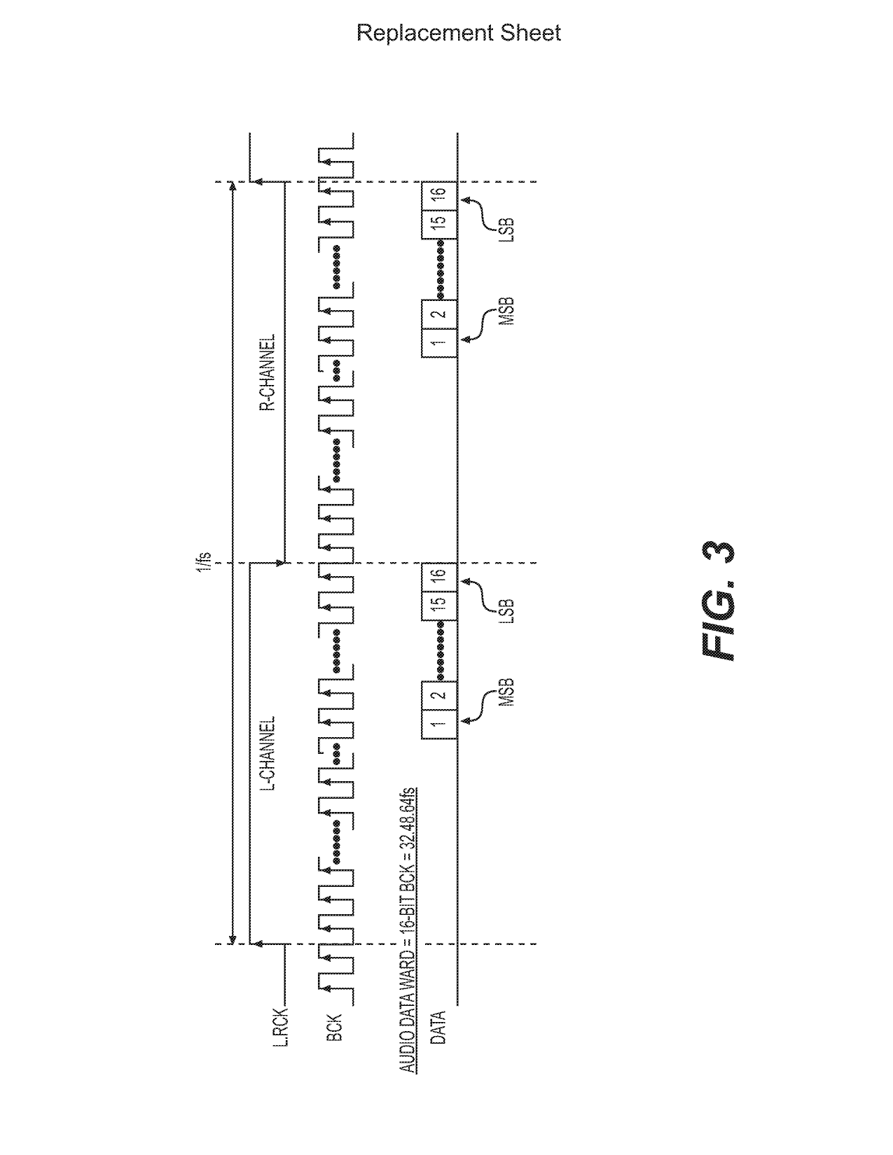

Turning now to FIG. 3, a signal diagram illustrates behavior of various signals of an audio IC including a configurable SDATA audio output port. The signal diagram illustrates a channel clock signal (LRCK), a bit clock signal (BCK) and a data signal (DATA). The data signal (DATA) is generated during a sample period (1/fs). According to the operations of the audio IC 100 described above, the data (e.g., digital audio data) in both the left channel (L) and the right channel (R) is forced to all 0 or all 1 according to an external condition. This is achieved by appropriately formatting the data fed to the configurable SDATA port 110, i.e., the SDATA output pin.

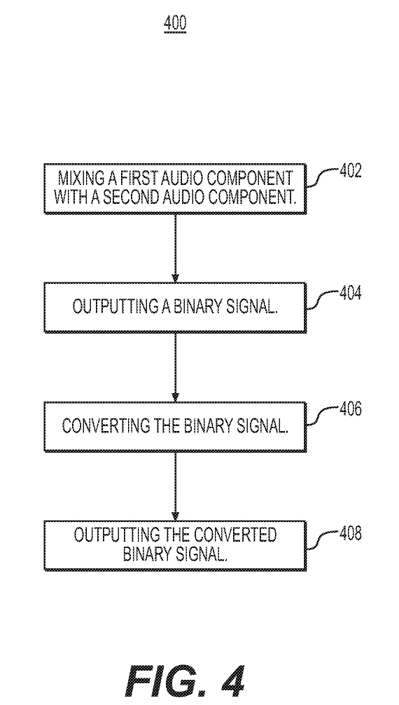

FIG. 4 illustrates a method 400 of outputting an audio signal according to certain, exemplary, non-limiting embodiments of the present invention. The method 400 includes mixing (402) a first input audio component with a second input audio component to generate a mixed audio signal, outputting (404) a binary signal based on a comparison between the mixed audio signal and a threshold value, converting (406) the binary signal into a data format corresponding to a serial data output port to generate a converted binary signal and outputting (408) the converted binary signal via the serial data output port.

As used herein, the term “module” refers to an application specific integrated circuit (ASIC), an electronic circuit, an electronic computer processor (shared, dedicated, or group) and memory that executes one or more software or firmware programs, a combinational logic circuit, and/or other suitable components that provide the described functionality, or an electronic hardware controller. When implemented in software, a module can be embodied in memory as a non-transitory machine-readable storage medium readable by a processing circuit and storing instructions for execution by the processing circuit for performing a method.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An audio integrated circuit (IC), comprises:
an electronic mixer circuit configured to output a mixed audio signal;
a comparator circuit in signal communication with the mixer, the comparator circuit configured to output a binary signal based on a comparison between the mixed audio signal and a threshold value;
a negator circuit in signal communication with the comparator circuit, the negator circuit configured to convert the binary signal into a data format corresponding to a serial data output port to generate a converted binary signal; and
a configurable serial data output port in signal communication with the negator circuit, the serial data output port configured to generate an output signal based on the converted binary signal.

2. The audio IC of claim 1, wherein the negator circuit generates the converted binary signal in response to converting at least one data value in the binary signal having a first state into a data value having a second state that is an inverse of the first state.

3. The audio IC of claim 2, wherein the negator circuit converts the binary signal into a two's compliment format.

4. The audio IC of claim 1, wherein the comparator is configured to continuously output binary signals as audio signals are continuously delivered to the electronic mixer.

5. A method of outputting an audio signal, the method comprising:
mixing a first input audio component with a second input audio component to generate a mixed audio signal;
outputting a binary signal based on a comparison between the mixed audio signal and a threshold value;
converting the binary signal into a data format corresponding to a serial data output port to generate a converted binary signal; and
outputting the converted binary signal via the serial data output port.

6. The method of claim 5, wherein converting the binary signal includes converting at least one data value in the binary signal having a first state into a data value having a second state that is an inverse of the first state so as to generate a converted binary signal.

7. The method of claim 6, further comprising converting the binary signal into a two's compliment format.

8. An audio integrated circuit (IC), comprises:
an electronic mixer circuit configured to output a mixed audio signal;
a comparator circuit in signal communication with the mixer, the comparator circuit configured to output a binary signal based on a comparison between the mixed audio signal and a threshold value; and
a data output in signal communication with the comparator and configured to receive the binary signal from the comparator.

8. The audio integrated circuit according to claim 7, wherein the data output is a general purpose input/output (GPIO) or a configurable serial data output port.

9. The audio integrated circuit according to claim 7, wherein the data output includes a plurality of data outputs including a general purpose input/output (GPIO) and a configurable serial data output port, and
wherein the binary signal can be selectively delivered to the general purpose input/output (GPIO) or the configurable serial data output port based on availability of the GPIO.
